(19) United States
(12) Patent Application Publication
(10) Pub. No.: US 2017/0214663 A1
(43) Pub. Date: Jul. 27, 2017

(54) SECURE MESSAGING SYSTEM

(71) Applicant: WELLPASS, INC., Arlington, VA (US)

(72) Inventors: Stan Berkow, New York, NY (US); Paul Biancaniello, Philadelphia, PA (US); Brad Hammonds, New York, NY (US)

(21) Appl. No.: 15/412,401

(22) Filed: Jan. 23, 2017

Related U.S. Application Data
(60) Provisional application No. 62/281,288, filed on Jan. 21, 2016.

(51) Int. Cl. H04L 29/06; H04L 12/58; G06F 21/62

(52) U.S. Cl. CPC H04L 63/0428; G06F 21/6245; G06F 21/6263; H04L 51/12

(57) ABSTRACT

The present system and methodology provides for consenting individuals to receive personal or other confidential information, via an electronic based message, in a secure manner. The system is capable of recognizing the content of the electronic based message and urging a user to send certain messages through secure channels if the message content requires such. In some instances, a user may be prevented from sending the message through unsecured channels if the message contains personal or other confidential information. Even further, the system is capable of creating logs of the use of the system to ensure compliance with the system as a whole.

### CLAIM OF PRIORITY

This application claims the priority of U.S. Ser. No. 62/281,288 filed on Jan. 21, 2016, the contents of which are fully incorporated herein by reference.

### FIELD OF THE EMBODIMENTS

The field of the embodiments of the present invention relate to a secure messaging system that enables users to receive varying levels of personal information via an electronic message.

### BACKGROUND OF THE EMBODIMENTS

A significant number of communications occur via electronic means, such as SMS, text messages, email, between various parties in any given day. These means of communication has made it easier for dissimilar parties to communicate and correspond at a moment's notice. For example, a doctor may be able to quickly email or text a patient to ask how they are feeling, remind them of an appointment, or the like. However, the convenience associated with these communication methods does have its drawbacks.

Many standard electronic communication formats are susceptible to interception by a third party either intentionally or unintentionally. At times, such an interception may be harmless but other times it is extremely damaging to a person or business or other entity. For example, one could gain access to one's bank account information, personal information, health information, proprietary company information, etc. This information can be used for nefarious gains and to defraud, blackmail, or otherwise extort these entities. Thus, safeguards such as encryption protocols may be implemented to help prevent the unwarranted interception or sharing of information.

Encryption and other information securement methods can only be implemented, however, assuming a person will readily employ the technology. In the event of sending a text message, many do not even consider the possibility of sending an encrypted communication. Thus, information that necessitates such protocols may be left to pass through unsecured channels.

There is a need for a system that provides for consenting individuals to receive personal or otherwise confidential information in a secure manner. Further, such a system needs to be able to recognize the content of a message and urge a user to send certain messages through secure channels if the message content requires such. Even further, the system needs to audit or create logs of the use to ensure compliance with the consent/security protocols and “flag” incorrect uses of the system. The present invention and its embodiments meets and exceeds these objectives. Review of related technology:

U.S. Patent Application 2014/0359022 pertains to the use of analytics to determine a number of key factors prior to a user sending a communication (e.g., an email or instant message, making an online social media post, or accepting or requesting friendship on a social media site). The analytics may determine content, subject, emotion, relationships, and other relevant details when users interact (e.g., with email or other social software). Any alerts/suggestions provided can be provided in real-time as the person types.

U.S. Patent Application 2009/0214034 pertains to a system and method for enabling electronic messaging with recipient-specific content, wherein multiple recipients may view non-private information and less than all recipients may view non-private information. In one embodiment, an author may select between two messaging processing algorithms to send messages to recipients, wherein one algorithm uses encryption and the other does not. In one embodiment, once private information is received by a recipient, its dissemination is automatically restricted. In one embodiment, the method of enabling messaging with recipient-specific content is transparent to email server machines. In one embodiment, HTML tags, comments and/or headers are used to mark information as private and to prevent such information from being viewed by unintended recipients. In one embodiment, non-private information is viewed by all recipients, but privately-highlighted non-private information is viewable by less than all recipients.

Various systems and methodologies are known in the art. However, their structure and means of operation are substantially different from the present disclosure. The other inventions fail to solve all the problems taught by the present disclosure. The present invention and its embodiments provide a system that allows for secured and unsecured communications, and alerts a user to use secure channels depending on the content of the message(s). At least one embodiment of this invention is presented in the drawings below and will be described in more detail herein.

### SUMMARY OF THE EMBODIMENTS

In general, the present invention and its embodiments provide an electronic communication system that enables adequate protection of individuals' private health information (PHI) and other sensitive information. The system monitors the content of communications and uses the content to cross reference the content with the implemented permission protocol for the particular user. Further, if such sensitive information may be transmitted due to the permission protocol, the system will still flag the message if it is attempted to be sent through a non-encrypted channel. Non-compliances with the various permission and encryption protocols may be flagged and stored in a log.

In one embodiment of the present invention there is a method of sending a secure message via an electronic device, the method comprising the steps of: garnering consent to send electronic communications to an electronic device of first user; composing an electronic based message, wherein the electronic based message is analyzed by a messaging system running a security based engine; sending the electronic based message to at least one recipient; wherein if confidential information is present in the electronic based message, then the messaging system alerting a composer to send the electronic based message with an applied encryption protocol, and wherein if confidential information is not present, then allowing the electronic based message to be sent via either conventional or encrypted channels.

In another embodiment of the present invention there is a method of sending a secure message via an electronic device, the method comprising the steps of: a first user consenting to receiving electronic based communications on an electronic device belonging to the first user, wherein there is a first consent level and a second consent level, the first consent level permitting general content messages to be sent to the first user and the second consent level permitting secure content messages to be sent to the first user; a second user composing an electronic based message, wherein the electronic based message is analyzed by a messaging system running a security based engine; the second user sending the electronic based message to at least the first user; wherein if the electronic based message contains secure content, then the messaging system alerts the second user to send the electronic based message with through a secured channel, and wherein if the secure content is not present in the electronic based message, then allowing the electronic based message to be sent via secured or unsecured channels.

In yet another embodiment of the present invention there is a system of sending secure electronic based messages between at least a first user and a second user, the system comprising: a first electronic computing device having a processor and a memory operable by the first user, the first electronic computing device; a second electronic computing device having a processor and a memory operable by the second user, the second electronic device; machine readable instructions stored on the memory and capable of being executed by the processor, the machine readable instructions embodying a security engine, wherein if secure information is present in the electronic based message, then the security engine alerts a user to send the electronic based message with an applied encryption protocol, and wherein if secure information is not present, then the user is permitted to send the electronic based message via unsecured or secured channels.

In general, the present invention succeeds in conferring the following, and others not mentioned, benefits and objectives.

It is an object of the present invention to provide a messaging system that provides for both secured and unsecured communication channels.

It is an object of the present invention to provide a messaging system that enables the users of the system to consent to receiving communications in accordance with the system.

It is an object of the present invention to provide a messaging system that analyzes the contents of a message.

It is an object of the present invention to provide a messaging system that alerts a user to confidential and/or personal information contained in a message to be sent.

It is an object of the present invention to provide a messaging system that prevents or limits the transmittal of confidential information through unsecured channels.

It is an object of the present invention to provide a messaging system that logs usage of the system allowing for compliance audits to ensure the system in used in accordance with various laws.

### BRIEF DESCRIPTION OF THE DRAWINGS

FIG. 1 is a flowchart outlining one iteration of a permission protocol in accordance with the present invention.

FIG. 2 is a flowchart outlining a second iteration of a permission protocol in accordance with the present invention.

FIG. 3 is a flowchart outlining a third iteration of a permission protocol in accordance with the present invention.

FIG. 4 is a flowchart detailing an overview of the permission process in accordance with embodiments of the present invention.

FIG. 5A is a first exemplary screen illustrating a typed message to be sent containing protected health information.

FIG. 5B is a second exemplary screen illustrating an encryption warning prompt a user before sending the message contained in FIG. 5A.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.”

Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s))” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O.

In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like.

Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state.

The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx.

Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA (PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. The operating system may be one specifically optimized to be run on a mobile computing device, such as iOS, Android, Windows Phone, Tizen, Symbian, and/or the like.

An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components.

After a Domain Name System (DNS) resolution portion of an HTTP request is resolved to a particular information server, the information server resolves requests for information at specified locations on the controller of the present invention based on the remainder of the HTTP request. For example, a request such as “http://123.124.125.126/myInformation.html” might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery (UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like.

The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Database of the Preferred Embodiment

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

### Embodiments of the Present Invention

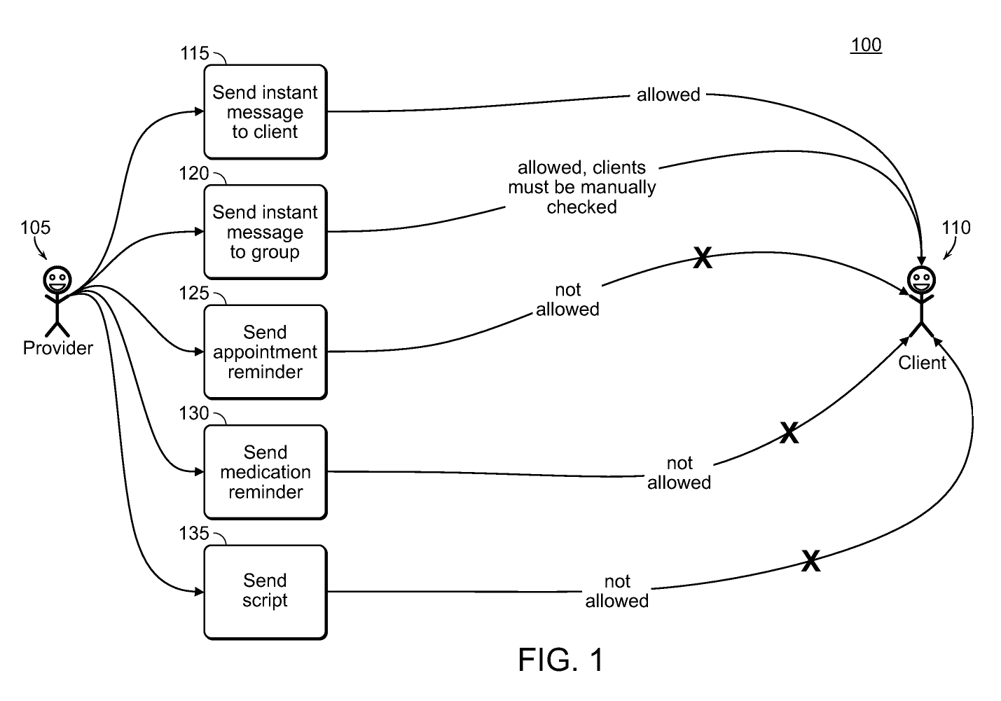

Referring now to FIG. 1, there is a flow chart demonstrating a first permission protocol scenario. Embodiments of the present invention may be required to comply with any number of regulations promulgated to govern the nature of automatic message and the content of those messages. The embodiments described herein may reflect the Telephone Consumer Protection Act of 1991 (TCPA), the Health Insurance Portability and Accountability Act (HIPAA), or a combination thereof. Other such regulations may be contained under the purview of operation of the present invention, however, they may not be discussed in substance herein.

In FIG. 1, scenario 100 is an overview where a patient or client 110 has not provided consent under a first protocol and/or a second protocol (e.g. TCPA, HIPAA, etc.) to a health care provider 105. A client 110 may be any number of users, groups of users, families, companies, individuals, and the like or any combination thereof. A health care provider 105 may be a health care provider such as a nurse, doctor, physician, physician's assistant, or receptionist. In other embodiments, the provider 105 may be a disease management company or non-clinical provider such as but not limited to health/nutrition coaches, community health workers and the like.

Thus, it is contemplated that at least five different methodologies can be used in the present invention and its embodiments for the provider 105 to contact the client 110. The provider may send an instant message to the client 115, the provider may send an instant message to a group 120, the provider may send an appointment reminder 125, the provider may send a medication reminder, and the provider may send a script to the client 135. This list is not intended to be exhaustive and other types of messages and their content may be sent to any number of individual or related users.

Here, the client 110 has not provided the necessary consent under the first protocol or the second protocol, or the third protocol, etc. Thus, the provider 105 is relegated to manually sending instant messages only or sending instant messages to a group. Appointment reminders, medication reminders, and sending of scripts would not be allowed. Consent may be received for such items either in writing, electronically, or via user input such as IVR or touchtone based messages.

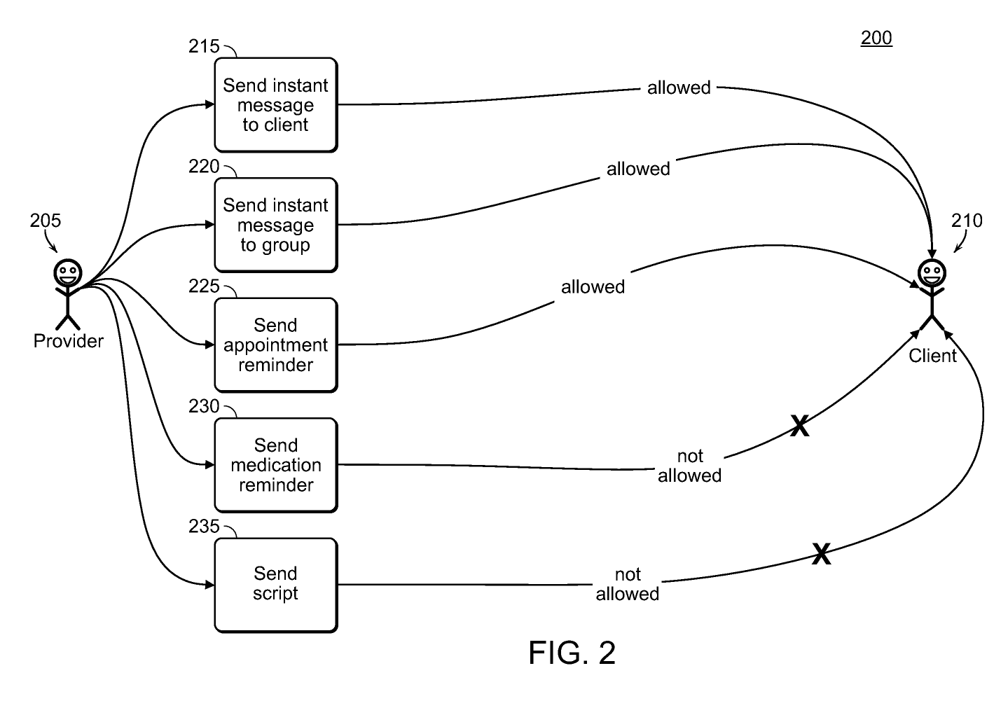

In FIG. 2, there is a scenario 200 where the client 210 has given the consent required for the first protocol but not the second protocol, in order to receive communications from the provider 205. Thus, the methods outlined in boxes 215, 220, and 225 are deemed to be permissible under the first protocol, and method outlined in boxes 230 and 235 are not allowed.

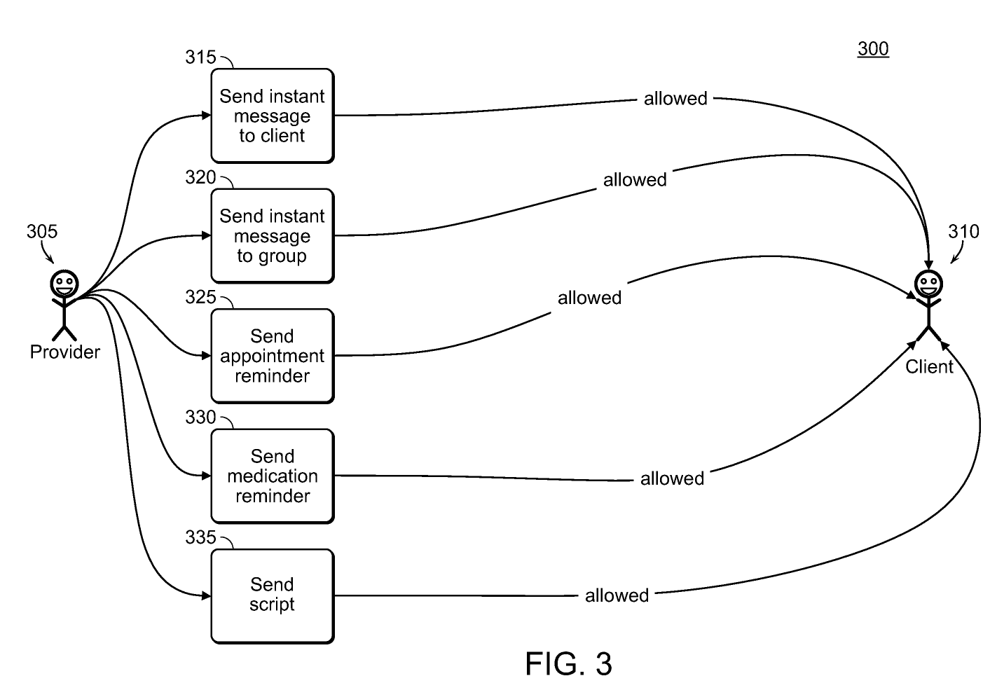

In FIG. 3, there is a scenario 300 where the client 310 has given the consent required for both the first protocol and the second protocol, in order to receive such communications from the provider 305. Thus, the methods outlined in boxes 215, 220, 225, 230, and 235 are deemed to be permissible under the permission protocols. These scenarios are not exhaustive and other combinations of permissions may exist and may be customizable by the user. For example, a user could consent to receiving all forms of communications except for the “scripts.” Thus, the system would monitor the communications being sent to and from that client for their particular permission protocol and allow and/or flag the messages appropriately.

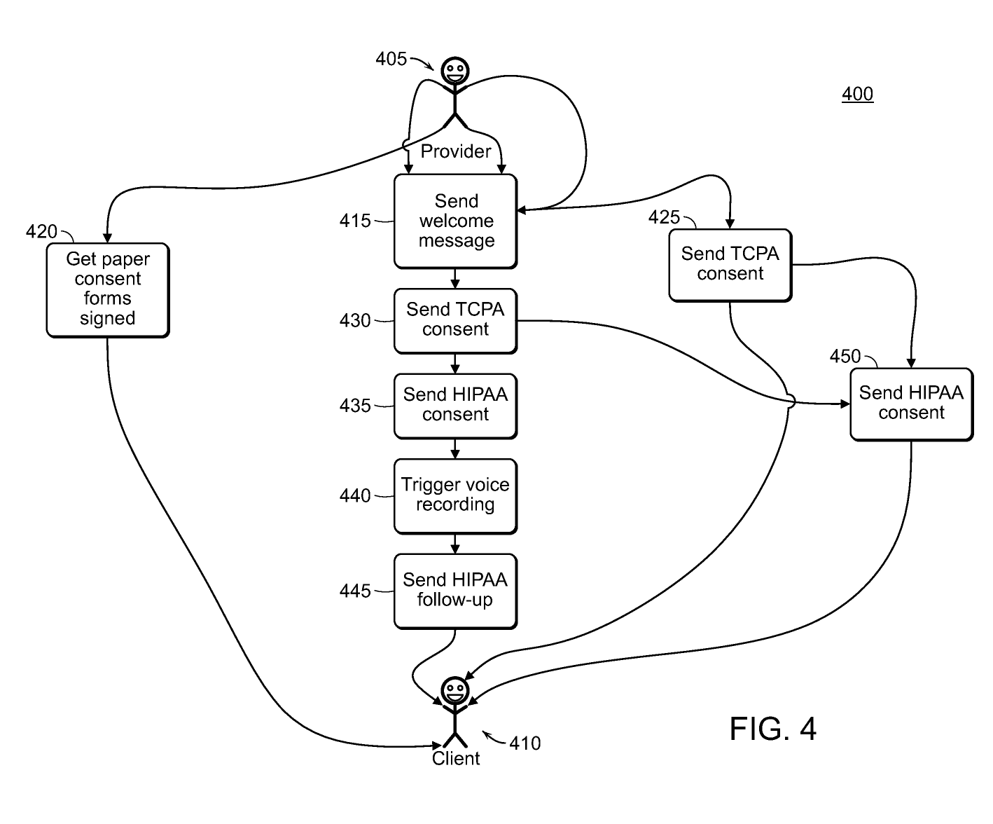

Referring now to FIG. 4, there is a flowchart 400 illustrating assorted methodologies of obtaining consent from a client to communicate with them electronically concerning their PHI and other sensitive information. Initially, when a new client or patient 410, signs up for the present system, a welcome message is sent as shown in box 415. The welcome message may be a text message or SMS or the like and may be “interactive.” Thus, the message may read “Hi, [name of client], it is [provider's name]. Is it alright if I text you at this number from time to time?” A client 410 can then preferably either reply “yes” or “no” to the provider 405. If the client 410 replies with a “no” then the prompts end and the user would fall into the permission protocol scenario described in FIG. 1.

If a client 410 replies with a “yes,” then the client 410 may receive a follow up message to obtain their consent as shown in box 430. Such a follow up message may read “Is it alright if I schedule messages to be automatically sent to your phone? Your phone company's standard messaging rates may apply.” Again the client 410, may reply “yes” or “no.” A “no” answer places the client in the permission protocol scenario shown in FIG. 2. A “yes” reply continues the message stream.

If a client 410 replies with a “yes,” to the prompt from box 430, then the client 410 may receive a follow up message to obtain their secondary consent as shown in box 435. This permission level enables the provider 405 to send medication reminders, assign scripts, and send messages containing other personal and private health information. Such a message may read “I would like to discuss your health records with you electronically, but need your permission to do so. Please reply with “ok” to this message to listen to a brief message detailing the type of information we would like to discuss with you and how it affects you as a patient.” Once the client 410, replies with an “ok” they will preferably receive an automated, pre-recorded phone call detailing permission protocol level as shown in box 440.

After the phone call, consent must then be given by the client 410 as shown in box 445. In order to provide consent, a client 410 must listen to the entire message and after which they will receive a prompt to, for example, press “1” for provide consent, and pressing “2” or no corresponding button on their phone will decline to give consent. If consent is given, the permission protocols are based off those shown in the scenario of FIG. 3.

In some instances, a client may choose to receive paper forms to be completed to provide their consent for the present system. As shown in box 420, paper forms can be mailed or otherwise provided to the client 410. The client may receive the written material visually rather than via auditory means. This may be especially helpful for clients who are hard of hearing or have vision problems and need large print documents. Once the documents are signed by the client 410, the provider 405 can manually check the corresponding permission boxes in the client profile.

Alternatively, as shown in boxes 425 and 450, only particular levels of consent may be given irrespective of the other permission levels. For example, a provider 405 may prompt the client 410 for permission, but the client 410 only want to provide permission for one privacy protocol and does not want to consent to another protocol. Thus, the multiple pathways provide for paper forms, standard consents, or partial consents.

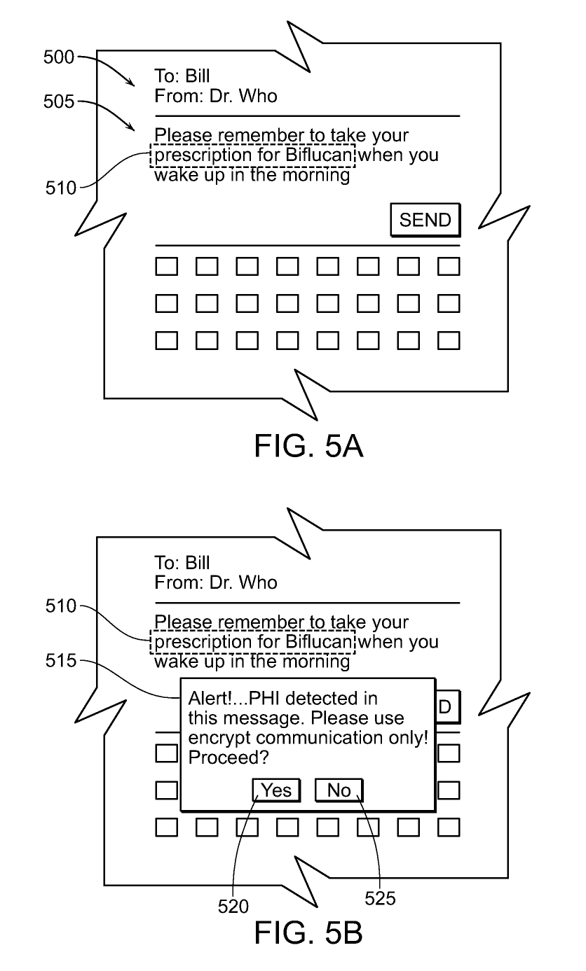

The permission protocols described above drive the nature and type of correspondence permitted between a client and a provider. In FIGS. 5A and 5B, there are example screens that demonstrate how the system may function in various embodiments of the present invention.

Referring now to FIG. 5A, there is an example screen 500 of a message to be sent to a client from a provider. In this example, the message 505 contains information related to one's medication and their dosage schedule. In particular, the message 505 contains PHI 510 relating to one's prescriptions. Such a communication may be made by a provider assuming the correct permission protocol, as described in FIGS. 1-4 or otherwise, has been prescribed to the client. However, some permission protocols, such as HIPAA, require that such information also be sent through secure, such as encrypted, means to prevent unauthorized access to the information contained therein.

In some instances, when creating a message a provider will have the option of sending either a secured or an unsecured message. On other embodiments, the system will prompt the provider, as shown in FIG. 5B, to send the message through a secured or encrypted channel. For example, in FIG. 5B, an alert 515 populates the screen preventing the message from initially being sent. This alert 515 may populate either during construction of the message or upon the provider hitting send.

The alert 515 notifies the provider that the message contains personal or private information 510 and that proper communication channels should be used. The provider can select from options 520, 525 to either proceed with the sending through the encrypted or secured channels or to go back and revise the message.

In some embodiments, logs are created and stored on a server database detailing each individual provider's use of the system. This usage can be monitored and audited as need be to confirm that proper protocols are being adhered and that information is not being sent through the improper channels. In some instances, the messages sent improperly are flagged or brought to the attention of the provider or their superiors thus providing a mechanism through which self-auditing and compliance can be maintained.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method of sending a secure message via an electronic device, the method comprising the steps of:
garnering consent to send electronic communications to an electronic device of first user;
composing an electronic based message, wherein the electronic based message is analyzed by a messaging system running a security based engine;
sending the electronic based message to at least one recipient;
wherein if confidential information is present in the electronic based message, then the messaging system alerting a composer to send the electronic based message with an applied encryption protocol, and
wherein if confidential information is not present, then allowing the electronic based message to be sent via either conventional or encrypted channels.

2. The method of claim 1 wherein the electronic based message is an instant message, SMS, text message, or email or a combination thereof.

3. The method of claim 1 further comprising the steps of creating a log of each electronic based message sent using the messaging system.

4. The method of claim 3 wherein the log is flagged when the security based engine determines improper sending of the electronic based message.

5. The method of claim 3 wherein the log registers and prevents an improper sending of the electronic based message.

6. A method of sending a secure message via an electronic device, the method comprising the steps of:
a first user consenting to receiving electronic based communications on an electronic device belonging to the first user,
wherein there is at least a first consent level and a second consent level, the first consent level permitting general content messages to be sent to the first user and the second consent level permitting secure content messages to be sent to the first user;
a second user composing an electronic based message, wherein the electronic based message is analyzed by a messaging system running a security based engine;
the second user sending the electronic based message to at least the first user;
wherein if the electronic based message contains secure content, then the messaging system alerts the second user to send the electronic based message with through a secured channel, and
wherein if the secure content is not present in the electronic based message, then allowing the electronic based message to be sent via secured or unsecured channels.

7. The method of claim 6 wherein the electronic based message is analyzed as it is composed.

8. The method of claim 6 wherein the first consent level is a TCPA consent and the second consent level is a HIPAA consent.

9. A system of sending secure electronic based messages between at least a first user and a second user, the system comprising:
a first electronic computing device having a processor and a memory operable by the first user, the first electronic computing device;
a second electronic computing device having a processor and a memory operable by the second user, the second electronic device;
machine readable instructions stored on the memory and capable of being executed by the processor, the machine readable instructions embodying a security engine,
wherein if secure information is present in the electronic based message, then the security engine alerts a user to send the electronic based message with an applied encryption protocol, and
wherein if secure information is not present, then the user is permitted to send the electronic based message via unsecured or secured channels.
